(19) United States
(12) Patent Application Publication
(10) Pub. No.: US 2024/0111118 A1
(43) Pub. Date: Apr. 4, 2024

(54) LENS SHIFT BACKLASH ELIMINATION DEVICE

(71) Applicant: Young Optics Inc., Hsinchu (TW)

(72) Inventors: Chia-Chang Lee, Hsinchu (TW); Chi-Yu Meng, Hsinchu (TW)

(73) Assignee: Young Optics Inc., Hsinchu (TW)

(21) Appl. No.: 17/979,779

(22) Filed: Nov. 3, 2022

(30) Foreign Application Priority Data
Oct. 4, 2022 (TW) 111137617

(51) Int. Cl. G02B 7/02

(52) U.S. Cl. CPC G02B 7/02

(57) ABSTRACT

A lens shift backlash elimination device includes a base, a transmission mechanism, and a lens. The transmission mechanism is disposed on the base and includes a first element, a second element, and an elastic element. The second element is mechanically connected to the first element. The elastic element is disposed between the first element and the second element, or abutted against the first element. The lens is mechanically connected to the transmission mechanism. The lens may be displaced relative to the base in a first direction.

### CROSS-REFERENCE TO RELATED APPLICATION

This application claims the priority benefit of Taiwan application serial no. 111137617, filed on Oct. 4, 2022. The entirety of the above-mentioned patent application is hereby incorporated by reference herein and made a part of this specification.

### BACKGROUND OF THE INVENTION

### Field of the Invention

The invention relates to an elimination device, and more particularly, to a lens shift backlash elimination device.

### Description of Related Art

The movement of a projection lens relative to a light valve may be achieved by a lens shift device. In general, in the design of the lens shift device, a gap is always reserved between the transmission shaft, between the worm and the worm gear, the cam transmission structure, the push transmission structure, and the screw and the nut structure, to avoid the components being too tight and causing inability to rotate or difficulty in rotating. However, if the gap is reserved, as long as the connection between the components is loose, a backlash is generated, thus causing the issue of idling components or the number of steps in the motor drive being not easy to control.

### SUMMARY OF THE INVENTION

The invention provides a lens shift backlash elimination device that may eliminate or absorb backlash, so as to effectively avoid the idling of the active element or the incorrect number of steps in the motor drive.

A lens shift backlash elimination device of an embodiment of the invention includes a base, a transmission mechanism, and a lens. The transmission mechanism is disposed on the base and includes a first element, a second element, and an elastic element. The second element is mechanically connected to the first element. The elastic element is disposed between the first element and the second element, or abutted against the first element. The lens is mechanically connected to the transmission mechanism. The lens may be displaced relative to the base in a first direction.

A lens shift backlash elimination device of an embodiment of the invention includes a base, a transmission mechanism, and a lens. The transmission mechanism is disposed at the base and includes a first element and a second element. The second element is mechanically connected to the first element, and one of the first element and the second element has an elastic structure. The lens is mechanically connected to the transmission mechanism, and the lens may be displaced relative to the base in a first direction.

A lens shift backlash elimination device of an embodiment of the invention includes a base, a transmission mechanism, and a lens. The transmission mechanism is disposed on the base and includes a first element, a second element, and an elastic element. The first element is a moving element. The second element is a fixed element, and mechanically connected to the first element, but not acting with the first element. The elastic element is disposed between the first element and the second element. The lens is mechanically connected to the transmission mechanism, and the lens may be displaced relative to the base in a first direction.

Based on the above, in the design of the lens shift backlash elimination device of the invention, the elastic element is disposed between the first element and the second element, or abutted against the first element; or, one of the first element and the second element has the elastic structure; or, the elastic element is disposed between the first element (the moving element) and the second element (the fixed element). Thereby, the backlash error between the first element and the second element may be eliminated or absorbed, and the idling of the first element or the second element or the incorrect number of steps in the motor drive may be avoided.

In order to make the aforementioned features and advantages of the disclosure more comprehensible, embodiments accompanied with figures are described in detail below.

### BRIEF DESCRIPTION OF THE DRAWINGS

FIG. 1A is a schematic three-dimensional view of a lens shift device.

FIG. 1B is a schematic front view of a lens shift backlash elimination device of an embodiment of FIG. 1A.

FIG. 2A is a schematic front view of a lens shift backlash elimination device of another embodiment of FIG. 1A.

FIG. 2B is a partially enlarged schematic front view of the transmission mechanism of FIG. 2A.

FIG. 3A is a schematic three-dimensional view of a lens shift backlash elimination device of another embodiment of FIG. 1A.

FIG. 3B is a schematic three-dimensional view of a lens shift backlash elimination device of another embodiment.

FIG. 4 is a schematic cross-sectional view of a lens shift backlash elimination device of another embodiment of FIG. 1A.

FIG. 5 is a schematic cross-sectional view of a lens shift backlash elimination device of another embodiment of FIG. 1A.

### DESCRIPTION OF THE EMBODIMENTS

In general, in the design of a shift device, a gap is reserved between the transmission shaft, between the worm and the worm gear, the cam transmission structure, the push transmission structure, and the screw and the nut structure, for example, to avoid the components being too tight and causing inability to rotate or difficulty in rotating. If a gap is reserved, backlash occurs whenever there is looseness in the connection between the components. The following takes a lens shift device as an example to illustrate how a lens shift backlash elimination device of the invention eliminates or absorbs the backlash between the lens shift device in the transmission shaft, between the worm and the worm gear, the cam transmission structure, the push transmission structure, and the screw and the nut structure, but not limited thereto. As long as there is a backlash between the active element and the driven element or between the moving element and the fixed element in the shift device, the backlash may be eliminated or absorbed by the lens shift backlash elimination device of the invention.

In the invention, the active element refers to an element that may drive other parts to move; the driven element refers to an element that may be driven by the active element; the moving element refers to an element that may be moved or rotated; the fixed part refers to an element that is fixed (not moving or rotating). The moving plate refers to a plate-like element that may generate movement.

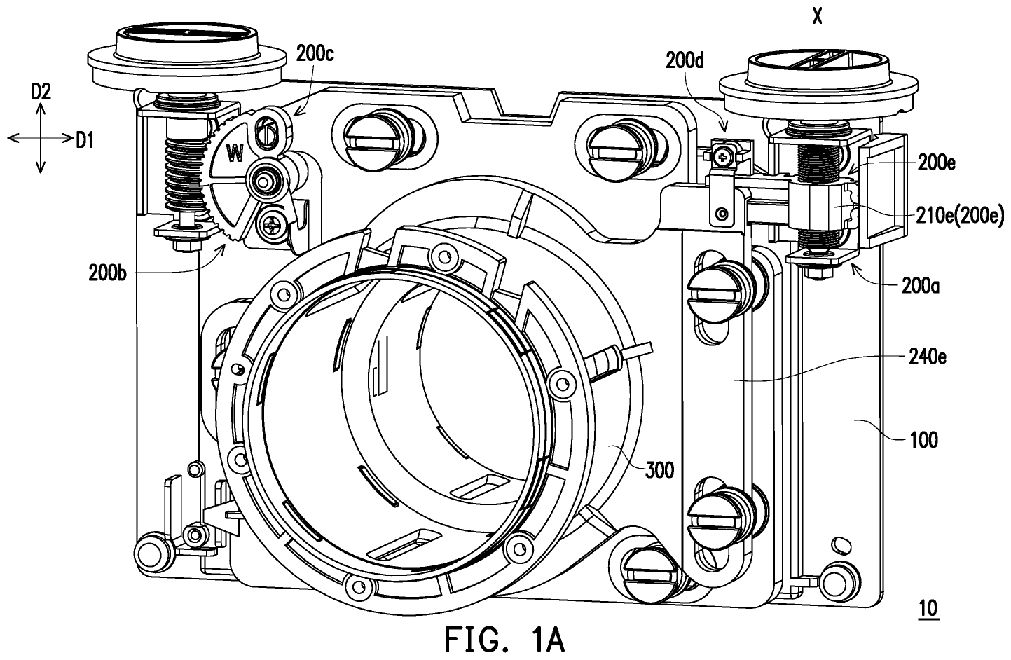

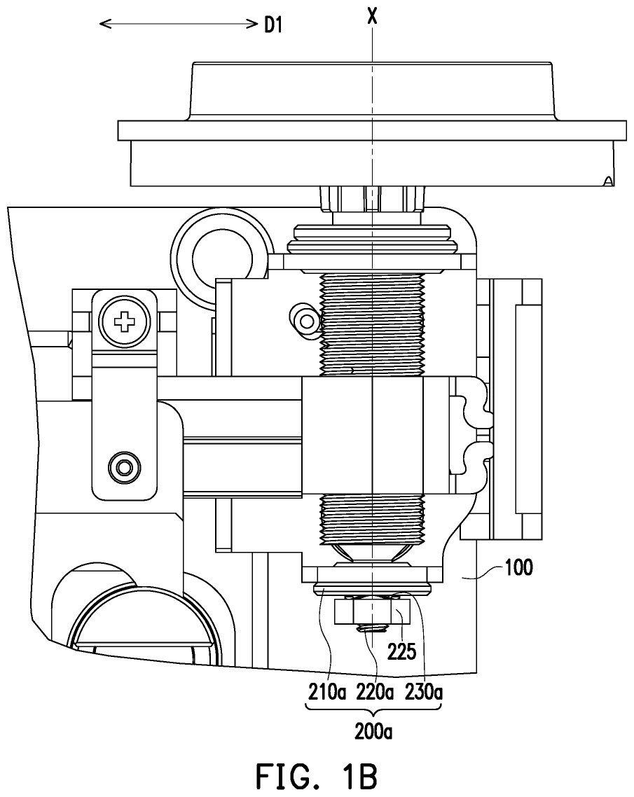

FIG. 1A is a schematic three-dimensional view of a lens shift device. FIG. 1B is a schematic front view of a lens shift backlash elimination device of an embodiment of FIG. 1A. Please refer to FIG. 1A and FIG. 1B at the same time. In the present embodiment, the lens shift backlash elimination device includes a base 100, a transmission mechanism 200a, and a lens 300. Here, the base 100 is the optical-mechanical housing of the lens shift device 10. The transmission mechanism 200a is disposed at the base 100, and the lens 300 and the transmission mechanism 200a are mechanically connected. The lens 300 may be displaced relative to the base 100 in a direction D2 (i.e., the first direction, the vertical direction).

In detail, please refer to FIG. 1B, in the present embodiment, the transmission mechanism 200a includes a second element 210a, a first element 220a, and an elastic element 230a. The second element 210a is mechanically connected to the first element 220a. The first element 220a is a moving element, embodied as a screw, and the second element 210a is a fixed element, embodied as a bearing, wherein the second element 210a does not act with the first element 220a. The elastic element 230a is disposed between the first element 220a and the second element 210a. Here, the first element 220a (i.e., the screw) is provided with a nut 225, and the elastic element 230a is provided between the nut 225 and the second element 210a (i.e., the bearing), wherein the elastic element 230a may be, for example, a wave-shaped elastic sheet or a coil spring, but not limited thereto.

In order to prevent the first element 220a (i.e., the screw) from moving in an axial direction X, a certain gap is reserved in the axial direction X of the first element 220a (i.e., the screw), and by disposing the elastic element 230a to be abutted against the second element 210a, the backlash error in the axial direction (i.e., between the first element 220a and the second element 210a) is absorbed by the design of micro-interference, to effectively avoid the idling of the moving elements or the incorrect number of steps in the motor drive.

Other embodiments of the invention are described below. It should be mentioned here that, the following embodiments adopt the reference numerals of the embodiment above and a portion of the content thereof, wherein the same reference numerals are used to represent the same or similar elements and descriptions of the same technical content are omitted. The omitted portions are as described in the embodiments above and are not repeated in the embodiments below.

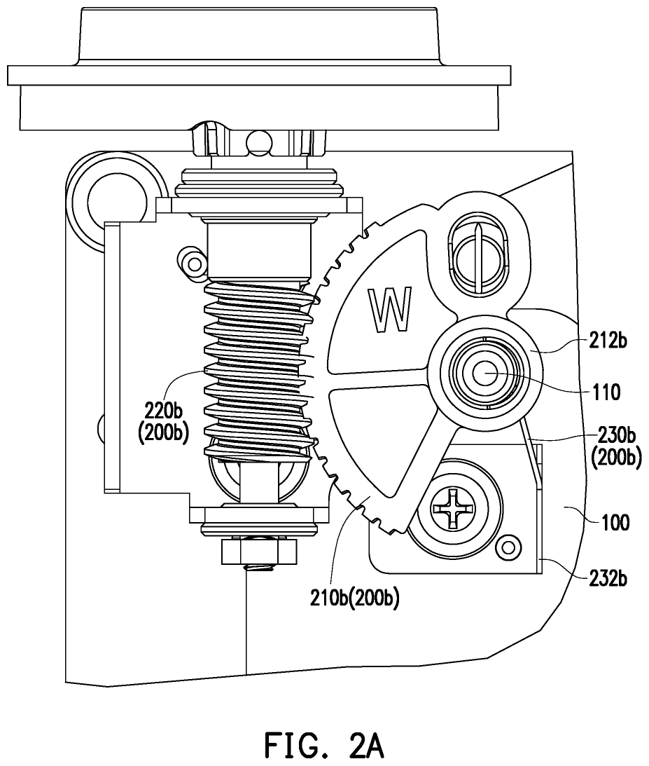

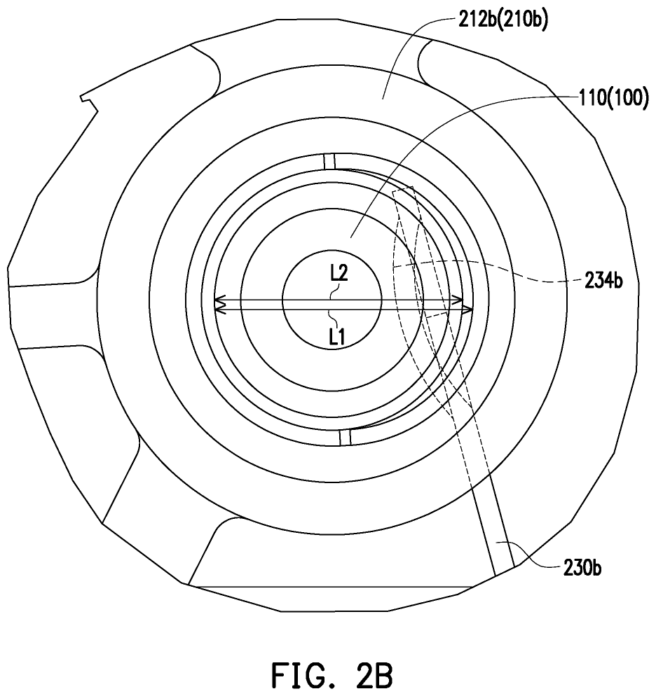

FIG. 2A is a schematic front view of a lens shift backlash elimination device of another embodiment of FIG. 1A. FIG. 2B is a partially enlarged schematic front view of the transmission mechanism of FIG. 2A. Please refer to FIG. 1A, FIG. 2A, and FIG. 2B at the same time. In the lens shift backlash elimination device of the present embodiment, a transmission mechanism 200b is disposed at the base 100, and the lens 300 and the transmission mechanism 200b are mechanically connected. One of a first element 210b and a second element 220b is an active element, and the other of the first element 210b and the second element 220b is a driven element. Here, the first element 210b of the transmission mechanism 200b is embodied as a worm gear, and the second element 220b is embodied as a worm. The teeth on the second element 220b (i.e., the worm) may be engaged with the teeth of the first element 210b (i.e., the worm gear), so when the second element 220b (i.e., the worm) is rotated, the first element 210b (i.e., the worm gear) is driven to be rotated. That is, the first element 210b is a driven element, and the second element 220b is an active element.

More specifically, the first element 210b of the present embodiment is provided with a combining portion 212b, and the base 100 is provided with a protruding block 110, wherein an inner diameter L1 of the combining portion 212b is greater than an outer diameter L2 of the protruding block 110. That is, there is a gap between the combining portion 212b and the protruding block 110. At this time, an end 232b of an elastic element 230b of the present embodiment is fixed at the base 100, and another end 234b of the elastic element 230b is abutted against the combining portion 212b of the first element 210b. Here, the elastic element 230b is, for example, an elastic sheet or a coil spring, but not limited thereto.

In the present embodiment, to meet the motion requirements of the transmission mechanism 200b, a certain gap is reserved between the teeth of the first element 210b (i.e., the worm gear) and the teeth of the second element 220b (i.e., the worm). However, to avoid backlash, a gap (i.e., the gap between the combining portion 212b and the protruding block 110) is disposed in the direction in which the central axis of the first element 210b (i.e., the worm gear) is away from the second element 220b (i.e., the worm), and via the other end 234b of the elastic element 230b abutted against the first element 210b (i.e., the worm gear) to exert force to the left, the first element 210b (i.e., the worm gear) is pressed against the direction of the second element 220b (i.e., the worm), thereby absorbing the backlash error between the first element 210b (i.e., the worm gear) and the second element 220b (i.e., the worm) to effectively avoid the idling of the active element or the incorrect number of steps in the motor drive.

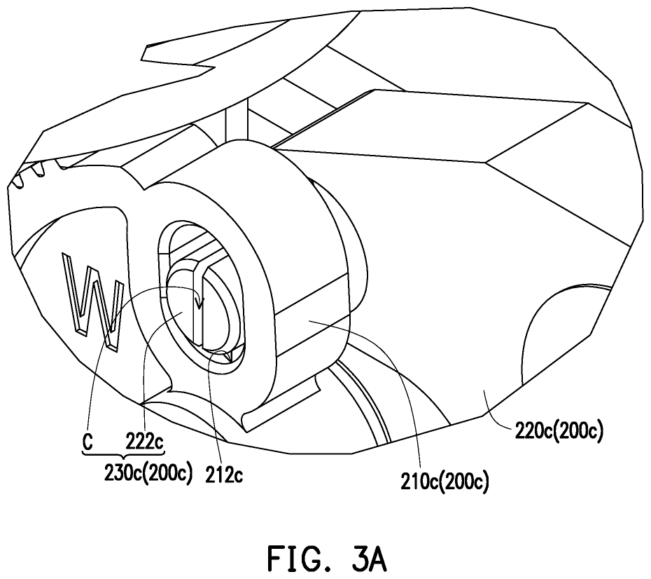

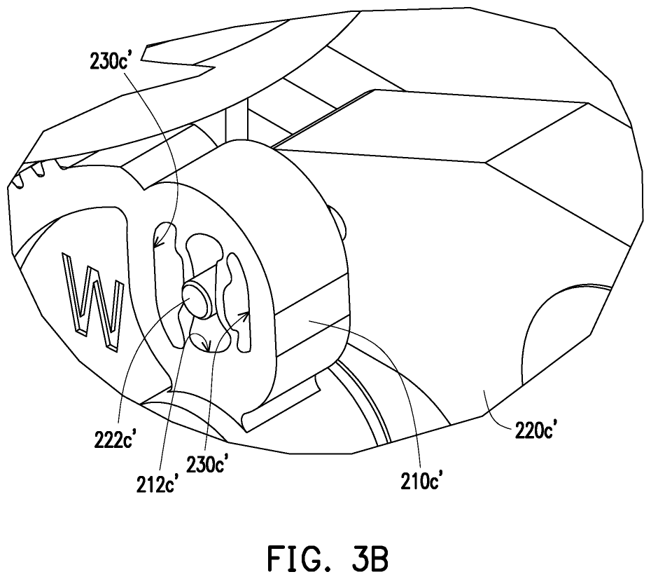

FIG. 3A is a schematic three-dimensional view of a lens shift backlash elimination device of another embodiment of FIG. 1A. FIG. 3B is a schematic three-dimensional view of a lens shift backlash elimination device of another embodiment. Please first refer to FIG. 1A and FIG. 3A at the same time. In the lens shift backlash elimination device of the present embodiment, a transmission mechanism 200c is disposed at the base 100, and the lens 300 and the transmission mechanism 200c are mechanically connected. A first element 210c of the transmission mechanism 200c is embodied as a worm gear, and a second element 220c is embodied as a moving plate. When the first element 210c (i.e., the worm gear) is rotated, the second element 220c (i.e., the moving plate) is driven to be moved. That is, the first element 210c is an active element, and the second element 220c is a driven element. One of the first element 210c and the second element 220c is provided with a through hole 212c, and the other of the first element 210c and the second element 220c is provided with a protruding post 222c. Here, the first element 210c has the through hole 212c, and the second element 220c is provided with the protruding post 222c, wherein the first element 210c and the second element 220c are mechanically connected via the through hole 212c and the protruding post 222c. Here, a groove C is provided on the protruding post 222c so that the protruding post 222c is used as an elastic element 230c. That is, the second element 220c has an elastic structure, but not limited thereto.

In another embodiment, a first element 210c′ may also have an elastic structure 230c′. Specifically, referring to FIG. 3B, the first element 210c′ not only is provided with a through hole 212c′ to fit a protruding post 222c′ of a second element 220c′, but also has the elastic structure 230c′ located at two sides of the through hole 212c′. Here, the elastic structure 230c′ is, for example, a groove or a curved structure. When the first elements 210c and 210c′ (i.e., the worm gear) are rotated, the protruding posts 222c and 222c′ are forced via the hole walls of the through holes 212c and 212c′. That is, the protruding posts 222c and 222c′ are restricted by the through holes 212c and 212c′, so that the second elements 220c and 220c′ (i.e., the moving plate) may be moved relative to the base 100 in a direction D1. Here, the material of the protruding posts 222c and 222c′ is, for example, an elastic material, such as plastic. By disposing the groove C on the protruding post 222c or disposing the elastic structure 230c′ to absorb the backlash error between the first elements 210c and 210c′ and the second elements 220c and 220c′ via the design of slight interference, the idling of the active element or the incorrect number of steps in the motor drive may be effectively avoided. Here, the transmission mechanism 200c is, for example, a cam transmission mechanism, and the rotation angle of the first elements 210c and 210c′ (that is, the worm gear) is, for example, a rotation of plus/minus 30 degrees, but not limited thereto.

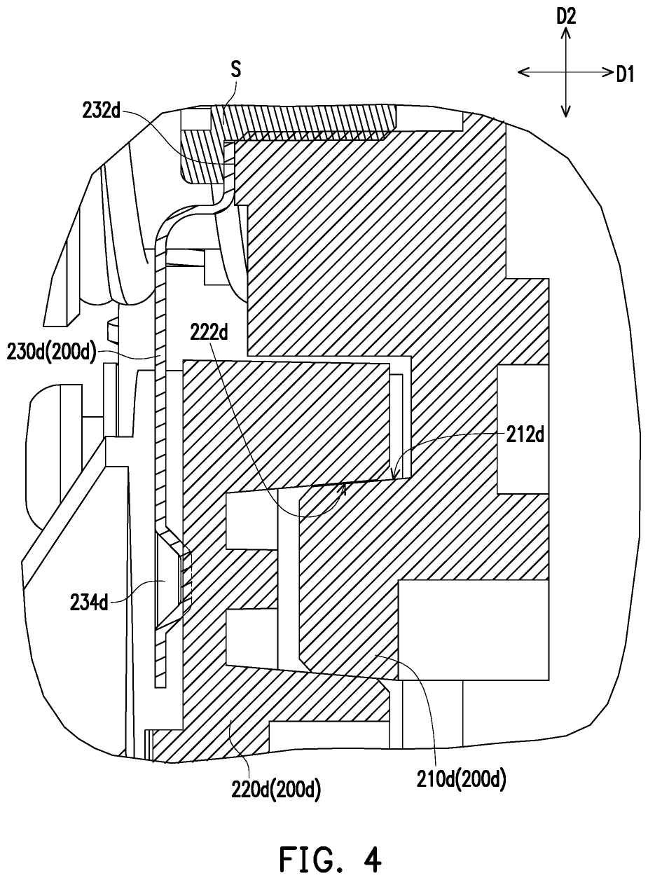

FIG. 4 is a schematic cross-sectional view of a lens shift backlash elimination device of another embodiment of FIG. 1A. Please refer to FIG. 1A and FIG. 4 at the same time. In the lens shift backlash elimination device of the present embodiment, a transmission mechanism 200d is disposed at the base 100, and the lens 300 and the transmission mechanism 200d are mechanically connected. A first element 210d of the transmission mechanism 200d is embodied as a first moving plate that may be displaced relative to the base 100 in a direction D2 (i.e., the first direction), and a second element 220d is embodied as a second moving plate that may be displaced relative to the base 100 in the direction D2. Here, the first element 210d is an active element, and the second element 220d is a driven element.

More specifically, the first element 210d of the present embodiment has a first inclined surface 212d, and the second element 220d has a second inclined surface 222d, wherein the first inclined surface 212d is in contact with the second inclined surface 222d. An end 232d of an elastic element 230d is fixed to the first element 210d or the base 100 via, for example, a screw S, and another end 234d of the elastic element 230d is in contact with the second element 220d. Here, the end 232d of the elastic element 230d is fixed on the first element 210d via, for example, the screw S, and the other end 234d of the elastic element 230d is in contact with the second element 220d. The elastic element 230d is, for example, a wave-shaped elastic sheet or a coil spring, but not limited thereto.

In the present embodiment, the gap between the first element 210b and the second element 220d is eliminated via the inclined cooperation between the first inclined surface 212d and the second inclined surface 222d between the first element 210d and the second element 220d, and via the arrangement of the elastic element 230d, the first element 210d and the second element 220d are in close contact with each other in a direction D4, thereby absorbing the backlash error between the first element 210d and the second element 220d to effectively avoid the idling of the active element or the incorrect number of steps in the motor drive. Here, the transmission mechanism 200d is, for example, a push transmission mechanism.

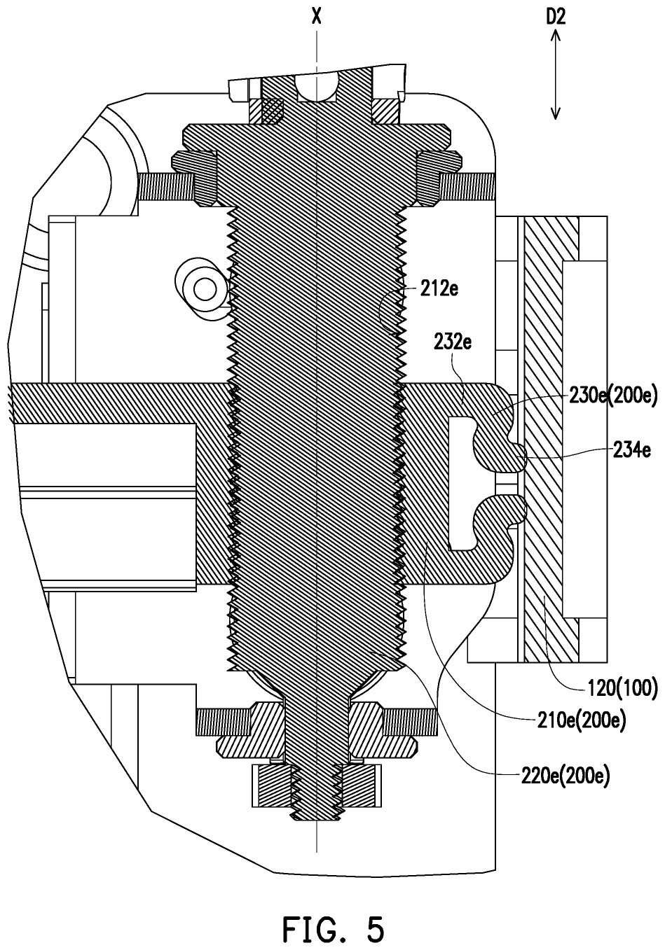

FIG. 5 is a schematic cross-sectional view of a lens shift backlash elimination device of another embodiment of FIG. 1A. Referring to FIG. 1A and FIG. 5 at the same time, in the lens shift backlash elimination device of the present embodiment, a transmission mechanism 200e includes a first element 210e, a second element 220e, and an elastic element 230e. The first element 210e is embodied as a moving element, and the second element 220e is embodied as a screw. Here, the first element 210e is a driven element, and the second element 220e is an active element. The first element 210e is provided with a screw portion 212e, and the screw portion 212e is sleeved on the second element 220e. The first element 210e may be displaced relative to the base 100 in the direction D2 (i.e., the first direction, the vertical direction), and the direction D2 is parallel to the axial direction X of the second element 220e.

Further, in the present embodiment, the lens shift backlash elimination device further includes a moving plate 240e mechanically connected to the first element 210e. The moving plate 240e may be displaced relative to the base 100 in the direction D2 via the transmission mechanism 200e, and the lens 300 is disposed on the moving plate 240e. An end 232e of the elastic element 230e is fixed at one of the base 100 and the first element 210e, and another end 234e of the elastic element 230e is abutted against the other of the base 100 and the first element 210e. Here, the end 232e of the elastic element 230e is fixed to the first element 210e, and the other end 234e of the elastic element 230e is abutted against the base 100. The base 100 is provided with a blocking wall 120, and the elastic element 230e is fixed at a side of the screw portion 212e and in contact with the blocking wall 120. By disposing the transverse elastic element 230e on the first element 210e, the backlash error between the first element 210e and the second element 220e may be absorbed, thereby effectively preventing the active element from idling or the incorrect number of steps in the motor drive.

It should be mentioned that, via the operation of the transmission mechanism 200a of FIG. 1B, the transmission mechanism 200b of FIG. 2A, the transmission mechanism 200c of FIG. 3, the transmission mechanism 200d of FIG. 4, and the transmission mechanism 200e of FIG. 5, the lens 300 may be moved relative to the base 100 in the direction D1 and the direction D2 in two dimensions (e.g., horizontal/vertical), and the movement in the two dimensions may be adjusted independently.

Based on the above, in the design of the lens shift backlash elimination device of the invention, the elastic element is disposed between the first element and the second element, or abutted against the first element; or, one of the first element and the second element has the elastic structure; or, the elastic element is disposed between the first element (the moving element) and the second element (the fixed element). Thereby, the backlash error between the first element and the second element may be eliminated or absorbed, and the idling of the first element or the second element or the incorrect number of steps in the motor drive may be avoided.

Although the invention has been described with reference to the above embodiments, it will be apparent to one of ordinary skill in the art that modifications to the described embodiments may be made without departing from the spirit of the disclosure. Accordingly, the scope of the disclosure is defined by the attached claims not by the above detailed descriptions.

What is claimed is:

1. A lens shift backlash elimination device, comprising:
a base;
a transmission mechanism disposed on the base, comprising:
a first element;
a second element mechanically connected to the first element; and
an elastic element disposed between the first element and the second element, or abutted against the first element; and
a lens mechanically connected to the transmission mechanism, and the lens may be displaced relative to the base in a first direction.

2. The lens shift backlash elimination device of claim 1, wherein one of the first element and the second element is an active element, and the other of the first element and the second element is a driven element.

3. The lens shift backlash elimination device of claim 2, wherein the active element is a worm, and the driven element is a worm gear; or, the active element is a worm gear, and the driven element is a moving plate.

4. The lens shift backlash elimination device of claim 2, wherein the active element is a first moving plate, and the driven element is a second moving plate.

5. The lens shift backlash elimination device of claim 2, wherein the base is provided with a protruding block, the driven element is provided with a combining portion, and an inner diameter of the combining portion is greater than an outer diameter of the protruding block, an end of the elastic element is fixed at the base, and another end of the elastic element is abutted against the driven element.

6. The lens shift backlash elimination device of claim 1, further comprising:
a moving plate mechanically connected to the first element, the moving plate may be displaced relative to the base in the first direction via the transmission mechanism, and the lens is disposed on the moving plate.

7. A lens shift backlash elimination device, comprising:
a base;
a transmission mechanism disposed on the base, comprising:
a first element; and
a second element mechanically connected to the first element, and one of the first element and the second element has an elastic structure; and
a lens mechanically connected to the transmission mechanism, and the lens may be displaced relative to the base in a first direction.

8. The lens shift backlash elimination device of claim 7, wherein one of the first element and the second element is an active element, and the other of the first element and the second element is a driven element.

9. The lens shift backlash elimination device of claim 8, wherein the active element is a worm, and the driven element is a worm gear; or, the active element is a worm gear, and the driven element is a moving plate.

10. The lens shift backlash elimination device of claim 8, wherein the active element is a first moving plate, and the driven element is a second moving plate.

11. The lens shift backlash elimination device of claim 8, wherein the base is provided with a protruding block, the driven element is provided with a combining portion, and an inner diameter of the combining portion is greater than an outer diameter of the protruding block, an end of the elastic element is fixed at the base, and another end of the elastic element is abutted against the driven element.

12. The lens shift backlash elimination device of claim 7, wherein the elastic structure is a groove or a curved structure.

13. The lens shift backlash elimination device of claim 10, wherein the first moving plate may be displaced relative to the base in the first direction, and the second moving plate may be displaced relative to the base in the first direction.

14. The lens shift backlash elimination device of claim 13, wherein the active element has a first inclined surface, the driven element has a second inclined surface, and the first inclined surface is in contact with the second inclined surface, an end of the elastic element is fixed at the active element or the base, and another end of the elastic element is in contact with the driven element.

15. The lens shift backlash elimination device of claim 7, wherein the driven element is provided with a screw portion, the screw portion is sleeved on the active element, the active element may be displaced relative to the base in the first direction, and the first direction is parallel to an axial direction of the driven element.

16. The lens shift backlash elimination device of claim 15, wherein the base is provided with a blocking wall, and the elastic element is fixed at a side of the screw portion and in contact with the blocking wall.

17. A lens shift backlash elimination device, comprising:
a base;
a transmission mechanism disposed on the base, comprising:
a first element as a moving element;
a second element as a fixed element, mechanically connected to the first element, but not acting with the first element; and
an elastic element disposed between the first element and the second element; and
a lens mechanically connected to the transmission mechanism, and the lens may be displaced relative to the base in a first direction.

18. The lens shift backlash elimination device of claim 17, wherein the elastic element is an elastic sheet.

19. The lens shift backlash elimination device of claim 18, wherein the first element is a screw, the second element is a bearing, the screw is provided with a nut, and the elastic sheet is provided between the nut and the bearing.

20. The lens shift backlash elimination device of claim 17, further comprising:
a moving plate mechanically connected to the first element, the moving plate may be displaced relative to the base in the first direction via the transmission mechanism, and the lens is disposed on the moving plate.
